(19) United States
(12) Patent Application Publication
(10) Pub. No.: US 2007/0094726 A1
(43) Pub. Date: Apr. 26, 2007

(54) System and method for neutralizing pestware that is loaded by a desirable process

(76) Inventors: Michael C. Wilson, Westminster, CO (US); Jefferson D. Horne, Boulder, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/259,706

(22) Filed: Oct. 26, 2005

(51) Int. Cl. G06F 12/14

(52) U.S. Cl. 726/22

(57) ABSTRACT

Systems and methods for managing pestware on a protected computer are described. In one implementation, a pestware construct is identified. Threads loaded by the pestware construct into a desirable process are identified and suspended. Neutralization of the pestware construct is accomplished by preventing code underlying pestware functions exported by the pestware construct from executing. In variations of the invention, registry entries associate with the pestware construct are detected and deleted, and the pestware construct is scheduled for deletion after the next reboot of a protected computer.

### RELATED APPLICATIONS

The present application is related to the following commonly owned and assigned application Ser. No. 10/956,578, Attorney Docket No. WEBR-002/00US, entitled System and Method for Monitoring Network Communications for Pestware; application Ser. No. 10/956,573, Attorney Docket No. WEBR-003/00US, entitled System and Method For Heuristic Analysis to Identify Pestware; application Ser. No. 10/956,574, Attorney Docket No. WEBR-005/00US, entitled System and Method for Pestware Detection and Removal; application Ser. No. 11/104,202; application Ser. No. (unassigned), Attorney Docket No. WEBR-013/00US, entitled System and Method for Scanning Obfuscated Files for Pestware filed herewith; application Ser. No. (unassigned), Attorney Docket No. WEBR-014/00US, entitled: System and Method for Scanning Memory for Pestware Offset Signatures; application Ser. No. (unassigned), Attorney Docket No. WEBR-018/00US, entitled System and Method for Scanning Memory for Pestware, filed herewith. Each of which is incorporated by reference in their entirety.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect some pestware, but many variations of pestware are difficult to detect with typical techniques. For example, pestware running in memory of a computer is often difficult to detect because it is disguised in such a way that it appears to be a legitimate process that is dependent from a trusted application (e.g., a word processor application). In other cases, pestware is obfuscated with encryption techniques so that a pestware file stored on a system hard drive may not be readily recognizable as a file that has spawned a pestware process. In yet other instances, pestware is known to be polymorphic in nature so as to change its size in memory or to change its starting address in memory.

Additionally, in other instances, pestware resists removal by running in desirable processes. Accordingly, current software is not always able to identify and remove pestware in a convenient manner and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include methods, computer-readable mediums, and systems for removing pestware from a protected computer. In one embodiment for example, the invention may be characterized as a method for removing pestware including identifying a pestware construct, identifying at least one pestware thread loaded by the pestware construct into a desirable process, suspending the pestware thread and neutralizing the pestware construct.

In another embodiment, the invention may be characterized as a computer-readable medium including executable instructions to identify a pestware construct, identify at least one thread by the pestware construct into a desirable process and neutralize the pestware construct.

In yet another embodiment, the invention may be characterized as a system for removing pestware. The system in this embodiment includes a detection module configured to identify a pestware construct and identify at least one pestware thread loaded by the pestware construct into a desirable process. The system also includes a removal module that is configured to suspend the pestware thread(s) and neutralize the pestware construct.

This and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of a protected computer in accordance with one implementation of the present invention;

FIG. 2 is a flowchart of one method for neutralizing a pestware construct on a protected computer;

FIG. 3 is a flowchart of one method for identifying and suspending pestware threads loaded by a pestware construct;

FIG. 4 is a flowchart of one method for neutralizing a pestware construct; and

FIG. 5 illustrates a block diagram of an example for identifying a pestware thread as being associated with a pestware construct on a protected computer.

### DETAILED DESCRIPTION

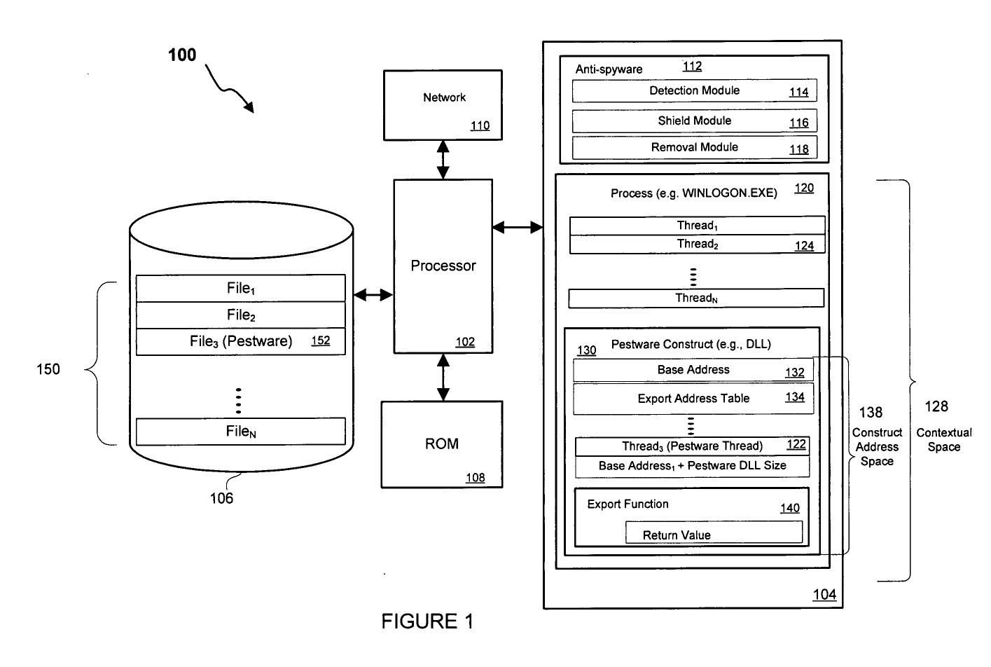

Referring first to FIG. 1, shown is a block diagram 100 of a protected computer/system in accordance with one implementation of the present invention. The term “protected computer” is used herein to refer to any type of computer system, including personal computers, handheld computers, servers, firewalls, etc. This implementation includes a processor 102 coupled to memory 104 (e.g., random access memory (RAM)), a file storage device 106, ROM 108, and a network 110.

As shown, the storage device 106 provides storage for a collection of N files 150, which includes a pestware file 152. The storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

As shown, an anti-spyware application 112 includes a detection module 114, a shield module 116 and a removal module 118, which are implemented in software and are executed from the memory 104 by the processor 102. The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

Also shown in the memory 104 is a desirable process 120, which in general, is an executable program that is a known and trusted application being executed by the processor 102 (e.g., a process associated with an operating system of the protected computer). In one embodiment, the desirable process 120 is winlogon.exe, however, one of ordinary skill in the art will recognize that the desirable process 120 is not limited to winlogon.exe.

It should be recognized that an operating system (not shown) of the protected computer 100 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

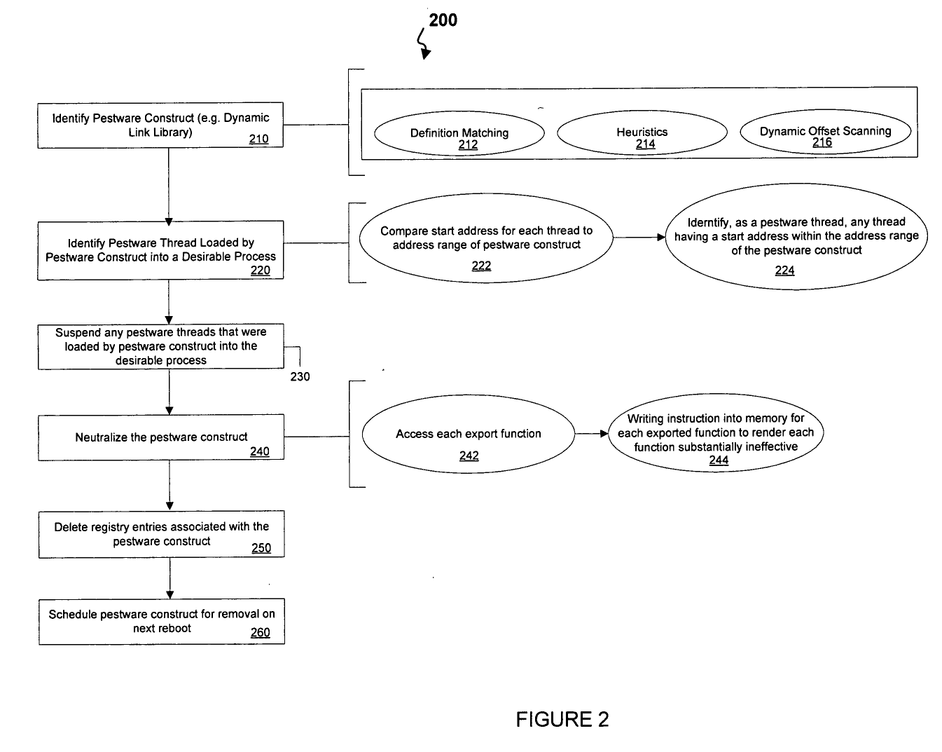

Shown in the desirable process 120 is a contextual space 128, which includes N threads depicted as threads_{1-N}. Included among the N threads is a pestware thread 122, which is a pestware function that is within the contextual space 128 of the desirable process 120. The other threads depicted in FIG. 1 are functions associated with the desirable process 120. As discussed further herein with reference to FIGS. 2, 3, 4 and 5, several embodiments of the present invention effectively and quickly identify and suspend the pestware thread 122.

Also shown within the contextual space 128 of the desirable process 120 is a pestware construct 130, which is associated with an address space 138. Within the address space 138 is a base address 132, an export address table 134, an export function 140 and the pestware thread 122. In several embodiments, the pestware construct 130 is a dynamic link library (DLL) that is loaded by the desirable process 120. It is contemplated, however, that the pestware construct 130 may be realized by other forms of computer executable instructions.

In the exemplary embodiment depicted in FIG. 1, the pestware thread 122 is a function loaded into the desirable process 120 by the pestware construct 130. Additionally, the export function 140 in the exemplary embodiment is a function that is exported by the pestware construct 130, and includes instructions to effectuate, at least in part, one or more pestware-related functions of the pestware construct 130.

In several embodiments, the export function 140 is accessed utilizing the export address table 134. As depicted in FIG. 1, the export function 140 has a return value, which in some embodiments is zero and in other embodiments is a specified value other than zero. The return value provides an acknowledgement to the pestware construct 130 that the export function 140 executed its intended pestware-related function(s).

For example, the export function 140 is designed to carry out its intended pestware function, when called by the pestware construct 130, by stepping through instructional code within the export function 140. As the export function 140 steps to the end of the code, it arrives at a return value that it returns to the pestware construct 130. This return value lets the pestware construct 130 know that the export function 140 fulfilled its intended purpose.

As discussed further herein with reference to FIGS. 2, 3, 4 and 5, several embodiments of the present invention identify and neutralize the pestware construct 130 without adversely affecting the desirable process 120. In some embodiments, for example, the export function 140 is modified so that when it is called by the pestware construct 130, the exported function 140 immediately provides the return value to the pestware construct 130 without performing its pestware-related function. In this way, the pestware construct 130 is effectively neutralized without adversely affecting the desirable process 120.

While referring to FIG. 1, simultaneous reference will be made to FIG. 2, which is a flowchart 200 depicting steps traversed in accordance with one method for neutralizing a pestware construct 130 (e.g., a DLL). As depicted in the exemplary steps in FIG. 2, a pestware construct 130 is initially identified by the detection module 114 (Block 210) using one or more of several techniques for identifying pestware. For example and without limitation, definition matching, heuristics and dynamic offset scanning techniques are utilized in some embodiments of the invention (Blocks 210, 212, 214, and 216).

In one embodiment, the detection module carries out a definition-based approach by comparing a representation of known pestware files (e.g., a cyclical redundancy check (CRC) of a portion of a known pestware file) with a representation (e.g., CRC) of a portion of the locked file. In one variation, only 500 Bytes of information are retrieved from data associated with the locked file and a CRC of the 500 Bytes of information retrieved from the file is compared with the known pestware definitions. If the 500 Bytes of retrieved information indicates the file is a potential pestware file, then a more thorough analysis (e.g., an analysis of the entire file) may be conducted. In this way, the comparison of each file with definitions of pestware files is expedited. Various techniques for detecting pestware are disclosed in the above-identified and related application entitled: System and Method for Monitoring Network Communications for Pestware.

A heuristics-based approach to identifying pestware is disclosed in the above identified and related application entitled: System and Method For Heuristic Analysis to Identify Pestware, and a dynamic offset scanning approach is disclosed in the above identified and related application entitled: System and Method for Scanning Memory for Pestware Offset Signatures. It is contemplated, however, that in other embodiments, yet other techniques for identifying pestware may be used.

As shown in FIG. 2, once the pestware construct 130 is identified (Block 210), pestware functions (e.g., pestware thread 122) that have been loaded in a desirable process 120 (e.g., a word processing-related process or system-level process) by the pestware construct 130, are identified (Blocks 220).

In some embodiments, pestware functions (e.g., the pestware thread 122) are identified by enumerating and comparing the start address of each function (e.g., the start address each of the threads_{1-N}) in the desirable process 120 with the address range of a pestware construct (e.g., the address space 138 in the pestware construct 130).

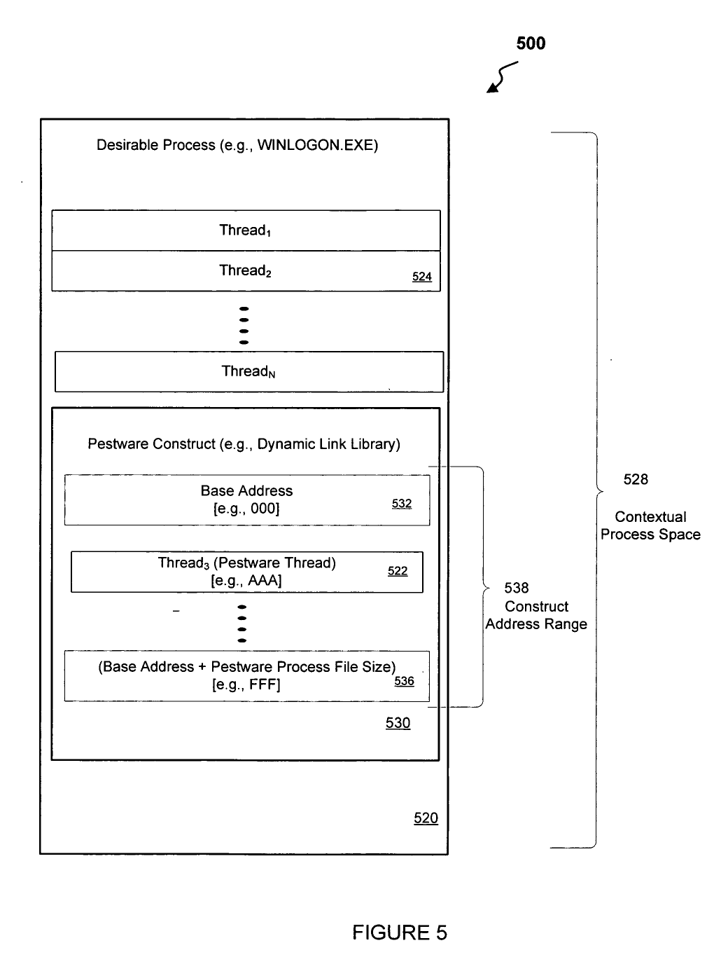

Referring to FIG. 1, for example, a start address of the pestware thread 122 is identified during an enumeration process and compared with the address space 138 to determine whether or not a match exists. A match exists when the start address of the pestware thread 122 falls within the address space 138 of the pestware construct 130. An exemplary pestware thread that includes a start address that falls within the address space of an associated pestware construct is described further with reference to FIG. 5.

As shown in FIG. 1, the address space 138 includes the space between and including the base address 132 and the end address of the pestware construct 130, which can be determined by adding the size of the pestware construct 130 to the base address. If the start address of a function (e.g., one of the threads_{1-N}) falls within the address space 138, then the function is identified as a pestware function that was loaded by the pestware construct 130 into the desirable process 120.

Returning to FIG. 2, if a comparison of a start address of a function and the address range for the pestware construct 138 results in a match, the function (e.g., the thread_{1-N}) that has a start address within the address range 138 of the pestware construct 130 is marked as a pestware function (Block 224). Such a marking indicates that the pestware function (e.g., the pestware thread 122) will be suspended because it is associated with the pestware construct 130.

Referring to FIG. 1, for example, after enumerating the start addresses for the threads_{1-N}, a comparison is made between the start address of each thread and the address range 138 of the pestware construct 130. In the case of thread₃ (i.e., the pestware thread 122), its start address falls within the address space 138. A detailed discussion of one embodiment for comparing the start address of each thread_{1-N} with the address space 138 of the pestware construct 130 is described with reference to FIG. 5. Once thread₃ is identified as having a start address that matches the address space 138 of the pestware construct 130, it is marked as a pestware function (e.g. pestware thread). This marking indicates that pestware thread is to be suspended.

Returning to FIG. 2, after a function (e.g., thread_{1-N}) is identified as a pestware thread, it is suspended (Block 230). The suspension operates to prevent the pestware function from further execution within the desirable process 120. In the exemplary embodiments, once the pestware thread 122 is suspended, (Block 230), the pestware construct 130 is neutralized (Block 240).

In one embodiment, as depicted in FIG. 2, the neutralization includes two sub steps depicted as Blocks 242 and 244. In this embodiment, each export function (e.g., export function 140) exported by the pestware construct 130 is accessed so as to obtain addresses for all functions exported by pestware construct 130 (Block 242). Referring to FIG. 1, for example, the export address table 134 is accessed to obtain the address for the export function 140 exported by the pestware construct 130.

Although FIG. 1 depicts only one pestware construct 130, one export function 140 and one pestware thread 122 it should be recognized that there may be several pestware constructs and each of the several pestware constructs may have multiple export functions and multiple pestware threads corresponding to it.

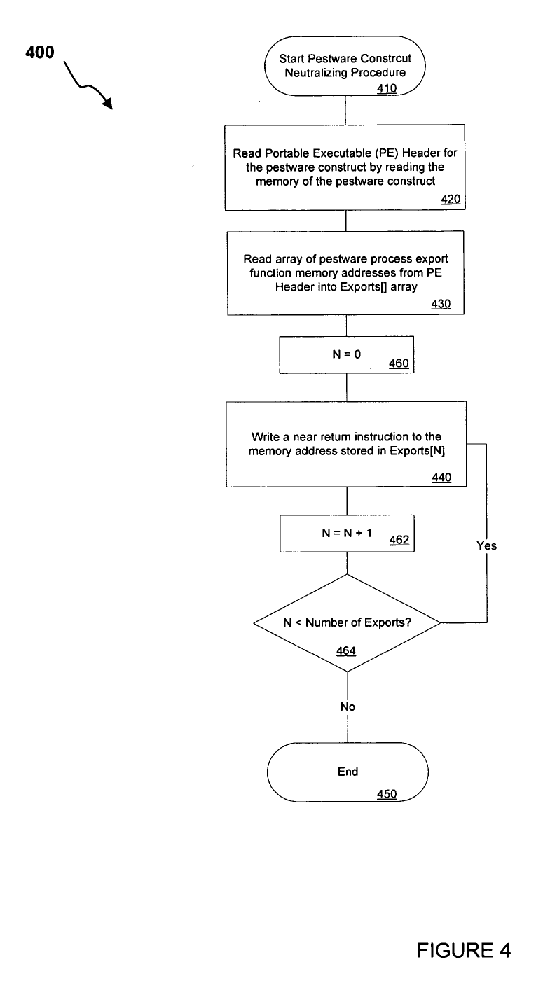

Returning to FIG. 2, after each export function is accessed, an instruction is written into the memory of each export function, which renders each exported function substantially ineffective. As used in this context, “substantially ineffective” encompasses a reduction or removal of the intended functional operation of the pestware function and/or construct. The “intended functional operation” includes the operation that the pestware function and/or construct was intended to do before the instruction is written into the export function's memory. Furthermore, the “intended functional operation” is generally related to any or all of the malicious functions that the export function 140 and/or pestware construct 130 was intended to perform. A further description of one embodiment for neutralizing a pestware construct (e.g., the pestware construct 130) is described with reference to FIG. 4.

In the exemplary embodiment depicted in FIG. 2, following the neutralization step depicted in Blocks 240, 242 and 244, any registry entries associated with the pestware construct are deleted (Block 250). This step is followed by the scheduling of the pestware construct for deletion after the next reboot (Block 260).

Advantageously, the steps outlined with reference to blocks 210-260 provide a method for neutralizing a pestware construct without drastically disrupting the normal operation of a protected computer (e.g., the protected computer 100). The steps of suspending a pestware function running in a desirable process and neutralizing a pestware construct leave the pestware in a more benign state and defenseless, without drastic interruptions or failures of the protected computer.

It should be recognized that the method depicted in FIG. 2 is exemplary only and that one of ordinary skill in the art will appreciate that one or more steps may be varied and/or omitted without departing from the scope of the present invention.

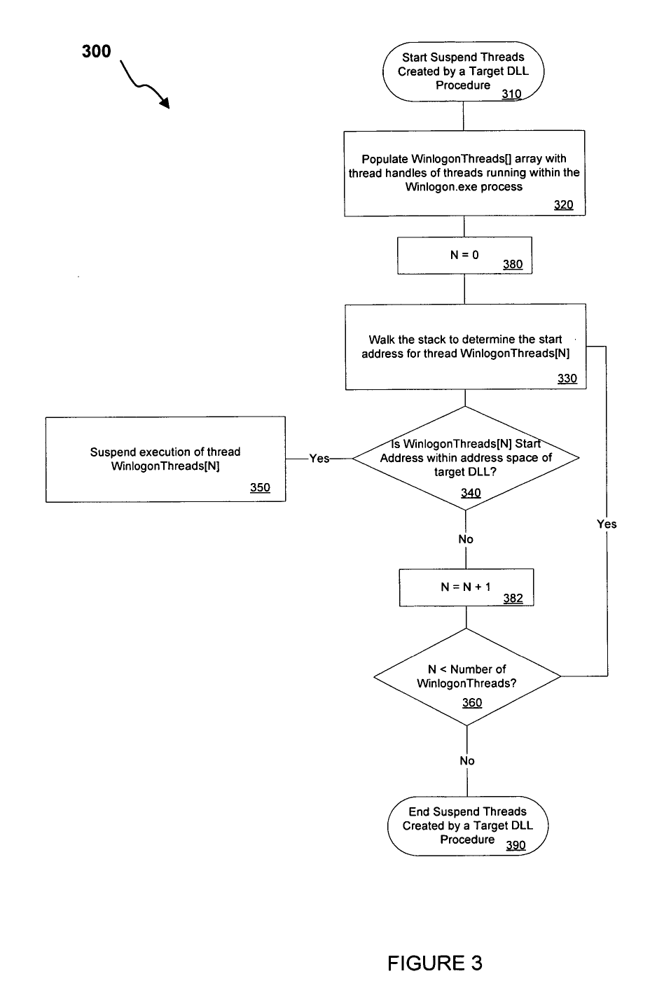

Referring next to FIG. 3, shown is a flowchart depicting steps carried out in accordance with one method of identifying and suspending pestware functions (e.g., the pestware thread 122) as depicted in steps 220-230 of FIG. 2. While referring to FIG. 3, simultaneous reference will be made to FIGS. 1 & 2. As shown in FIG. 3, the threads_{1-N} are enumerated and their handles (e.g. IDs) are populated into a list (e.g., an array) (Block 320).

The list in this embodiment provides an access structure that allows a handle of each of the threads_{1-N} to be accessed. One of ordinary skill in the art will recognize that populating an array with the handles of each of the threads_{1-N} is one of many methods for allowing each handle to be accessed. In this embodiment the array is used to advance through each handle, one-by-one, starting with the first handle stored in the list and ending with the last handle stored in the list (Blocks 380, 330, 382 and 360).

As each of the threads_{1-N} is accessed, the start address of each of the threads_{1-N} is compared with the address space of an identified pestware construct (e.g., the pestware construct 130) (Block 340). If the start address is greater than the base address of the pestware construct, but less than the end address of the pestware construct, then the thread was presumably started by the pestware construct. The end address can be determined, in one method, by summing the base address and the image size of the pestware construct.

If one of the threads_{1-N} has a start address within the address space of the identified pestware construct (e.g., within the address space 138 of the pestware construct 130), then that thread is suspended (Block 350). If the thread_{1-N} does not have a start address within the address space of the pestware construct, then the start address of the next thread in the array is compared to the address space of the identified pestware construct.

After suspension of a pestware thread (e.g., the pestware thread 122), the start address of the next thread in the array is compared to the address space of the identified pestware construct. The comparison and suspension, when appropriate, continues until the start addresses of every thread in the array is compared to the address space of the identified pestware construct (Blocks 330-360, & 382).

It should be recognized that the method depicted in FIG. 3 is exemplary only and that one of ordinary skill in the art will appreciate that one or more steps may be varied and or omitted without departing from the scope of the present invention.

Referring next to FIG. 4, shown is a flowchart depicting steps carried out in accordance with one method of effectuating blocks 240-244 of FIG. 2 in order to neutralize a pestware construct. As shown in FIG. 4, the exemplary neutralization method reads the Portable Executable (PE) header for an identified pestware construct (e.g., the pestware construct 130) by reading memory of the identified pestware construct (Block 420). The PE header contains a table of all functions exported (e.g., the export function 140) by the identified pestware construct. As shown in FIG. 4, a list in the form of an array named Exports[ ] is created to store the start addresses of export functions (e.g. the export function 140) in the table contained in the PE header. The Exports[ ] array is used to aid in accessing each export function (Block 430). In one embodiment, each export function in the Exports[ ] array is accessed and a near return instruction (e.g., Return From Procedure) is written to each export function's start address in memory (Block 440). This will cause the export functions, when called, to immediately return without executing any further instructions. It is recognized by one of ordinary skill in the art that using the immediate return instruction at the entry point of the function is only one example of preventing the export function from executing its intended function.

In another embodiment each export function in the Exports[ ] array is accessed and an instruction that initiates a jump to a return value within the code of each export function is written in place of the near return. The jump instruction prevents each export function from executing at least a portion of its functional code. This instruction tricks each pestware construct associated with each export function into thinking an export function has executed its intended pestware construct by returning a return value that each pestware construct expects to receive after each export function executes all of its intended functions.

It should be recognized that the method depicted in FIG. 4 is exemplary only and that one of ordinary skill in the art will appreciate that one or more steps may be varied and or omitted without departing from the scope of the present invention.

Referring next to FIG. 5, shown is a block diagram 500 representing a portion of a protected computer/system in accordance with one embodiment of the present invention. In particular, FIG. 5 depicts an environment in which the steps described with reference to Blocks 220-224 depicted in FIG. 2 are carried out.

In the exemplary embodiment, in order to suspend a pestware thread 522 and neutralize the pestware construct 530, the pestware construct 530 and the desirable process 520 are accessed as they are running in real-time. In this embodiment, the pestware construct 530 is accessed in order to determine its contextual base address (e.g., 000), and then the size of the pestware construct 530 is determined (e.g., FFF). As depicted in FIG. 5, an address space 538 is calculated by adding the size of the pestware construct 530 to the base address (e.g., address space: 000 to (000+FFF=FFF)).

While the pestware construct 530 and desirable process 520 are still running, the contextual space 528 of the desirable process 520 is examined, thread-by-thread, to determine whether any thread_{1-N} was loaded into the desirable process 520 by the pestware construct 530. For example, a pestware thread 522 loaded into the desirable process 520 by the pestware construct 530 has a load/start address (e.g., AAA) that falls within the address space calculated above (e.g., AAA falls within address space 000 to FFF). All threads with load/start addresses that fall within the contextual address space 528 of the pestware construct 530 will be suspended.

It is important to note that in this embodiment the base address 532 for the pestware construct 530 may be contextually different when the pestware construct 530 is running in executable memory at time1 than when the pestware construct 530 is running in executable memory at time2, wherein time1 occurs at a different time than time2 (e.g. time1 is 2 pm on Sunday, while time2 is 5:45 am on Tuesday). When the addresses for the threads_{1-N} running in the desirable process 520 are compared to the contextual address range 538 of the pestware construct 530, the contextual space 528 of the desirable process 520 is aligned with the contextual space 538 of the pestware construct 530 regardless of the time as long as both the desirable process 520 and the pestware construct 530 run at the same time together. This alignment ensures that the load/start address of threads_{1-N} residing in the contextual space 528 of the desirable process 520 can be effectively related to the contextual address space 538 of the pestware construct.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method of removing pestware, comprising:
identifying a pestware construct, wherein the pestware construct is loaded by a desirable process;
identifying at least one pestware thread that is loaded by the pestware construct into the desirable process;
suspending the at least one pestware thread; and
neutralizing the pestware construct.

2. The method of claim 1, wherein
the pestware construct is a dynamic link library, the desirable process is a system-level process selected from the group consisting of winlogon.exe, systemidle.exe, systemreg.exe, lsass.exe, spool.exe and svchost.exe, and the identifying the pestware construct includes using a technique selected from the group consisting of a definition matching approach, a heuristics approach, and a dynamic offset scanning approach.

3. The method of claim 1, wherein the identifying the at least one pestware thread loaded by the pestware construct into the desirable process comprises:
comparing a start address of each of a plurality of threads running in the desirable process to an address range of the pestware construct; and
marking, as the at least one pestware thread, any of the plurality of threads that has a start address within the address range of the pestware construct.

4. The method of claim 3, wherein the comparing a start address of each of the plurality of threads running in the desirable process to an address range of the pestware construct comprises:
populating a list, the list including the start address of each of the plurality of threads; and
advancing through the list to determine whether any of the plurality of threads has a start address within the address range of the pestware construct.

5. The method of claim 1, wherein the neutralizing the pestware construct is accomplished without removing the pestware construct.

6. The method of claim 1, wherein neutralizing the pestware construct comprises:
accessing each function exported by the pestware construct; and
writing an instruction into memory for each of the exported functions that renders each of the exported functions substantially ineffective.

7. The method of claim 6, wherein the accessing each function exported by the pestware construct comprises:
reading a list of addresses for each of the export functions;
populating a second list with the export function addresses; and
advancing through the second list to access each of the export functions.

8. The method of claim 1, wherein the identifying the pestware construct, identifying at least one pestware thread loaded by the pestware construct into the desirable process, suspending the at least one pestware function, and neutralizing the pestware construct, are performed at a computer, the method further comprising:
deleting registry entries associated with the pestware construct; and
scheduling the pestware construct for deletion after the next reboot.

9. A computer-readable medium comprising executable instructions to:
identify a pestware construct, wherein the pestware construct is loaded by a desirable process;
identify at least one pestware thread that is loaded by the pestware construct into the desirable process;
suspend the at least one pestware thread; and
neutralize the pestware construct.

10. The computer-readable medium of claim 9, wherein
the pestware construct includes a dynamic link library,
the desirable process is a system-level process selected from the group consisting of winlogon.exe, systemidle.exe, systemreg.exe, lsass.exe, spool.exe and svchost.exe, and
the executable instructions to identify the pestware construct include instructions selected from the group consisting of definition matching instructions, heuristics-approach instructions, and dynamic offset scanning instructions.

11. The computer-readable medium of claim 9, wherein the executable instructions to identify the at least one pestware thread loaded by the pestware construct into the desirable process include executable instructions to:
compare a start address of each of a plurality of threads running in the desirable process to an address range of the pestware construct; and
identify, as the at least one pestware thread, any of the plurality of threads that has a start address within the address range of the pestware construct.

12. The computer-readable medium of claim 11, wherein the executable instructions to compare a start address of each of the plurality of threads running in the desirable process to an address range of the pestware construct include executable instructions to:
populate a list including the start addresses of each of the plurality of threads; and
advance through the list to determine whether any of the plurality of threads has a start addresses within the address range of the pestware construct.

13. The computer-readable medium of claim 9, wherein the executable instructions to neutralize the pestware construct include instructions to neutralize the pestware construct without removing the pestware construct.

14. The computer-readable medium of claim 9, wherein the executable instructions to neutralize the pestware construct include executable instructions to:
access each function exported by the pestware construct; and
write an instruction into memory for each of the exported functions that renders each of the exported functions substantially ineffective.

15. The computer-readable medium of claim 14, wherein the executable instructions to access each function exported by the pestware construct include executable instructions to:
read a list of addresses for each of the export functions;
populate a second list with the export function addresses; and
advance through the second list to access each of the export functions.

16. The computer-readable medium of claim 9, further comprising executable instructions to:
delete registry entries associated with the pestware construct; and
schedule the pestware construct for deletion after the next reboot.

17. A system of removing pestware, comprising:
a detection module configured to:
identify a pestware construct that is loaded by a desirable process; and
identify at least one pestware thread loaded by the pestware construct into the desirable process; and
a removal module configured to:
suspend the at least one pestware thread; and
neutralize the pestware construct.

18. The system of claim 17, wherein
the pestware construct is a dynamic link library,
the desirable process is a system-level process selected from the group consisting of winlogon.exe, systemidle.exe, systemreg.exe, lsass.exe, spool.exe and svchost.exe, and
the detection module is configured to identify the pestware construct by using a technique selected from the group consisting of a definition matching approach, a heuristics approach, and a dynamic offset approach.

19. The system of claim 17, wherein the detection module is configured to identify the at least one pestware thread loaded by the pestware construct into the desirable process by:
comparing a start address of each of a plurality of threads running in the desirable process to an address range of the pestware construct; and
identifying, as the at least one pestware thread, any of the plurality of threads that has a start address within the address range of the pestware construct.

20. The system of claim 19, wherein the detection module is configured to compare a start address for each thread running in the desirable process to an address range of the pestware construct by:
populating a list with the start addresses of the threads; and
advancing through the list to determine whether any of the threads have start addresses within the address range of the pestware construct.

21. The system of claim 17, wherein the removal module is configured to neutralize the pestware construct without removing the pestware construct.

22. The system of claim 17, wherein the removal module is configured to neutralize the pestware construct by:
accessing each function exported by the pestware construct; and
writing an instruction into memory for each of the exported functions that renders each of the exported functions substantially ineffective.

23. The system of claim 22, wherein the removal module is configured to access each function exported by the pestware construct by:
reading a list of addresses for each of the export functions;
populating a second list with the export function addresses; and
advancing through the second list to access each of the export functions.

24. The system of claim 17, wherein the removal module is configured to:
delete registry entries associated with the pestware construct; and
schedule the pestware construct for deletion after the next reboot.
